(19) United States
(12) Patent Application Publication
(10) Pub. No.: US 2018/0232003 A1
(43) Pub. Date: Aug. 16, 2018

(54) VEHICLE OPERATION PEDAL DEVICE

(71) Applicant: TOYODA IRON WORKS CO., LTD., Toyota-shi (JP)

(72) Inventor: Tomohiro TSUGUMA, Nissin-shi (JP)

(73) Assignee: TOYODA IRON WORKS CO., LTD., Toyota-shi (JP)

(21) Appl. No.: 15/955,240

(22) Filed: Apr. 17, 2018

Related U.S. Application Data
(63) Continuation of application No. PCT/JP2016/077631, filed on Sep. 20, 2016.

(30) Foreign Application Priority Data
Dec. 10, 2015 (JP) 2015-241058

(51) Int. Cl. G05G 1/44; G05G 1/46; B60T 7/06

(52) U.S. Cl. CPC G05G 1/44; B60T 7/06; G05G 1/46

(57) ABSTRACT

A brake pedal device 1 has: a pedal bracket 5 having a first side plate member 10 and a second side plate member 20; and an operating pedal 30 supported pivotally by a first support shaft 6 comprising a caulking pin 50. The caulking pin 50 has a large-diameter section 51 and a pair of caulked portions 52. A load receiving part 13, etc. have a predetermined load receiving part thickness T at the opening peripheral of an insertion hole 12, etc. irrespective of a side plate thickness t of the first side plate member 10 etc. The caulked portions 52 protrude axially from each of end surfaces of the large diameter section 51 by a second axial length LB larger than the load receiving part thickness T. The caulked portions 52 are compressed and deformed axially by a work load of a caulking.

### CROSS-REFERENCE TO RELATED APPLICATION

This application is based upon and claims the benefit of priority of the prior Japanese Patent Application No. 2015-241058, filed on Dec. 10, 2015, the entire contents of which are incorporated herein by reference.

### FIELD

The present disclosure relates to a vehicle operation pedal device that includes a pedal bracket having a pair of side plates, a caulking pin, and an operation pedal.

### BACKGROUND

Conventionally, a vehicle operation pedal device includes a pedal bracket having a pair of side plates, a fixation pin for fixing the pair of side plates, and an operation pedal pivotally arranged with respect to the pedal bracket between the pair of side plates and is configured to displace an output member by a depressing operation of the operation pedal.

As a disclosure related to the vehicle operation pedal device as described above, for example, a disclosure described in Japanese Unexamined Utility Model Application Publication No. 06-018052 is known. A vehicle operation pedal device disclosed in the Japanese Unexamined Utility Model Application Publication No. 06-018052 is configured to include a bracket having a pair of side plates, a clutch pedal for operating a clutch used for transmitting power in a vehicle, and a support pin. In the disclosure described in the Japanese Unexamined Utility Model Application Publication No. 06-018052, the support pin is fixed to the pair of side plates by caulking a distal end part of the support pin with the clutch pedal and the pair of side plates inserted by the support pin, and the support pin is attached as a pivot center of the clutch pedal.

### SUMMARY

According to an aspect of the embodiments, a vehicle operation pedal device includes a pedal bracket that includes a pair of side plates arranged with a predetermined gap in a vehicle width direction, and that is secured to a vehicle body side member; a caulking pin that is inserted into each insertion hole formed on the pair of side plates in the pedal bracket, and that fixes the pair of side plates by caulking; and an operation pedal that is pivotally arranged with respect to the pedal bracket between the pair of side plates, and that includes a depressing part used for a depressing operation toward a vehicle front side; wherein the pair of side plates includes a load receiving part, in which formed in opening periphery of the insertion hole, configured to a plate thickness of a predetermined first dimension, and the caulking pin including: a large-diameter portion configured to an outer diameter dimension larger than an inner diameter dimension of the insertion hole and an axial length corresponding to the gap between the pair of side plates; and a pair of caulked portions that protruded along an axial direction of the caulking pin from each of end surfaces of the large-diameter portion by a predetermined second dimension larger than the first dimension, wherein the pair of caulked portions that includes an outer diameter dimension smaller than the inner diameter dimension of the insertion hole and that deformed in the axial direction by caulking.

The object and advantages of the invention will be realized and attained by means of the elements and combinations particularly pointed out in the claims.

It is to be understood that both the forgoing general description and the following detailed description are exemplary and explanatory and are not restrictive of the invention.

### BRIEF DESCRIPTION OF DRAWINGS

FIG. 1 is a side view illustrating a schematic configuration of a brake pedal device according to the first embodiment;

FIG. 2 is a rear view illustrating a schematic configuration of the brake pedal device according to the first embodiment;

FIG. 3 is a sectional view that is taken along line X-X of FIG. 1 and is illustrated the vicinity of a first support shaft before caulking in the first embodiment;

FIG. 4 is a sectional view that is taken along line X-X of FIG. 1 and is illustrated the vicinity of the first support shaft after caulking in the first embodiment;

FIG. 5 is a sectional view that is taken along line Y-Y of FIG. 1 and is illustrated the vicinity of a fixation pin before caulking in the first embodiment;

FIG. 6 is a sectional view that is taken along line Y-Y of FIG. 1 and is illustrated the vicinity of the fixation pin after caulking in the first embodiment; and

FIG. 7 is a sectional view that is taken along line X-X of FIG. 1 and is illustrated the vicinity of a first support shaft in a brake pedal device according to the second embodiment.

### DESCRIPTION OF EMBODIMENT

With respect to a vehicle operation pedal device, a configuration of a pedal bracket may be changed according to various vehicles to which the pedal bracket is mounted. For example, in a case weight reduction and cost reduction etc. of a vehicle operation pedal device are expected, the expectation is met by thinning plate thickness of a pair of side plates forming the pedal bracket. In a case improvement of rigidity of the vehicle operation pedal device is expected, it is assumed that the plate thickness of the pair of side plates is increased.

As the disclosure described in the Japanese Unexamined Utility Model Application Publication No. 06-018052, when end parts of a pin are caulked to fix the pin between a pair of side plates, thickness around an insertion hole in each side plate and shape of the end parts of the pin deformed by caulking, and the like are important for excellent caulking, and high dimension precision of the shapes is expected.

Especially, as the disclosure described in the Japanese Unexamined Utility Model Application Publication No. 06-018052, when a caulking pin fixed by caulking is used as a support shaft for pivotally supporting an operation pedal and the like with respect to a pedal bracket, to avoid preventing pivoting of an operation pedal and the like, delicate caulking needs to be performed and strict precision of caulking is expected. In this case, since the thickness around the insertion hole in each side plate and the shape of the end parts of the pin deformed by caulking, and the like become even more important, strict dimension precision of the thickness and the shapes is expected.

When a configuration of the pedal bracket is changed into a configuration in which the pair of side plates are arranged with a fixed gap and plate thickness of each side plate is different from each other, if a caulking pin corresponding to the plate thickness of each side plate is not prepared, the thickness around the insertion hole in each side plate and the shape of the end parts of the pin deformed by caulking, and the like are not able to be the prescribed appropriate thickness and shape and the like, causing a problem of caulking precision. When a plurality of kinds of caulking pins corresponding to the plate thickness of each side plate are used, an increase in the kind of caulking pin used in a vehicle operation pedal device leads to a deterioration in efficiency of manufacturing a vehicle operation pedal device and an increase in manufacturing costs thereof.

In view of this point, in a case the configuration of the pedal bracket is changed into the configuration in which the pair of side plates are arranged with a fixed gap and the plate thickness of each side plate is different from each other, when one kind of caulking pin is used for the pair of side plates, the thickness around the insertion hole in each side plate and the shape of the end parts of the pin deformed by caulking, and the like are brought into a significantly different state because the plate thickness of each side plate is different from each other. In this case, caulking of the end parts of the caulking pin is not able to be performed appropriately, and defects in caulking can occur sometimes. Especially, when the caulking pin serves as the support shaft of the operation pedal and the like, there is a risk that pivoting of the operation pedal is prevented and rattling of the operation pedal and the like is generated, due to deterioration in caulking precision.

### First Embodiment

An embodiment (first embodiment) applied to a brake pedal device 1 for a service brake in a vehicle operation pedal device according to the present disclosure will be hereinafter described in detail with reference to the drawings.

(Schematic Configuration of a Brake Pedal Device)

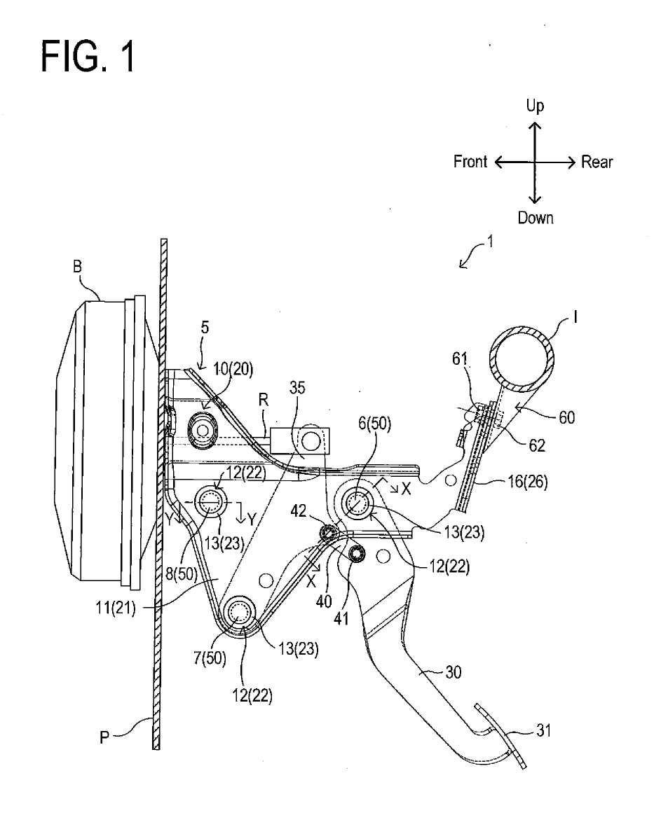

First, a schematic configuration of the brake pedal device 1 according to the first embodiment will be described in detail with reference to the drawings. In FIG. 1, each unit arranged inside a pedal bracket 5 is indicated with a virtual line (broken line) to clearly illustrate a structure on the inner side.

The brake pedal device 1 according to the first embodiment is securely arranged with respect to a dash panel P that partitions an engine room and a vehicle compartment, an instrument panel reinforcement I, and a vehicle body side bracket 60 serving as vehicle body side members. The brake pedal device 1 includes the pedal bracket 5, an operation pedal 30, an intermediate lever 35, and a coupling link 40. The brake pedal device 1 is configured to displace an operating rod R of a brake booster B toward a vehicle forward side when the operation pedal 30 is pivoted by a depressing operation of the operation pedal 30, thus generating a braking force with respect to a vehicle.

The brake booster B is integrally fixed to a vehicle front side (i.e., engine room side) of the dash panel P, and includes the operating rod R serving as an output member. When the operating rod R is displaced toward the vehicle front side, the brake booster B doubles the braking force transmitted through the operation pedal 30 and transmits the doubled braking force to the vehicle. The operating rod R is arranged so as to project out into the vehicle compartment on a vehicle rear side from the dash panel P, and is configured to be displaceable in a front and back direction of the vehicle.

As illustrated in FIG. 1, the instrument panel reinforcement I is arranged on the vehicle rear side (driver's seat side) of the dash panel P, and configures one part of a vehicle body side member in the present disclosure. The instrument panel reinforcement I has high rigidity, and thus generally, the possibility of being displaced toward the vehicle rear side and the deformation amount when a large load is input from the vehicle forward side such as at the time of collision are smaller than the dash panel P.

The instrument panel reinforcement I is integrally fixed to the vehicle body side bracket 60. The vehicle body side bracket 60 and the instrument panel reinforcement I form a vehicle body side member in the present disclosure. In the vehicle body side bracket 60, a rear side part of the pedal bracket 5 (attachment/securing part described later) is fastened and fixed with a nut 61 and a bolt 62 at one location (see FIG. 1).

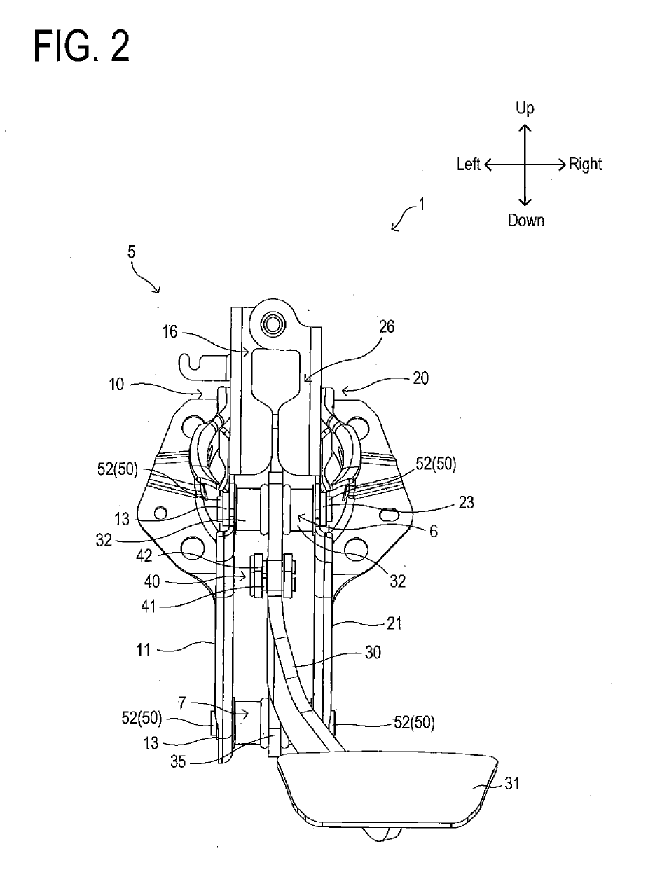

As illustrated in FIG. 1 and FIG. 2, the pedal bracket 5 is configured by a first side plate member 10 and a second side plate member 20 that are secured with respect to a vehicle compartment side of the dash panel P using a bolt, and the like and that face each other with a predetermined gap in a vehicle width direction (hereinafter referred to as a side plate gap W). A specific configuration of the pedal bracket 5 will be described later.

A first support shaft 6 is arranged on a vehicle rearward side in the pedal bracket 5. The first support shaft 6 is extended substantially horizontally and substantially parallel with the vehicle width direction between the first side plate member 10 and the second side plate member 20 configuring the pedal bracket 5. The first support shaft 6 is configured by a caulking pin 50 described later, a gap between the first side plate member 10 and the second side plate member 20 is fixed at the side plate gap W by caulking the first support shaft 6, and the first support shaft 6 is inserted into a boss 32 formed on an upper part of the operation pedal 30 to pivotally support the operation pedal 30.

A second support shaft 7 is located on the vehicle lower front side in the operation pedal 30 and is arranged to extend parallel to the first support shaft 6. The second support shaft 7 is configured by the caulking pin 50 in the same as the first support shaft 6, and the second support shaft 7 is extended substantially horizontally and substantially parallel with the vehicle width direction between the first side plate member 10 and the second side plate member 20. A gap between the first side plate member 10 and the second side plate member 20 is fixed at the side plate gap W by caulking the second support shaft 7, and a lower part of the intermediate lever 35 is pivotally supported by the second support shaft 7.

A fixation pin 8 is arranged on the vehicle forward side in the pedal bracket 5 and above the second support shaft 7. The fixation pin 8 is extended substantially horizontally and substantially parallel with the vehicle width direction between the first side plate member 10 and the second side plate member 20. The fixation pin 8 is configured by the caulking pin 50 in the same as the first support shaft 6 and the second support shaft 7, and a gap between the first side plate member 10 and the second side plate member 20 is fixed at the side plate gap W by caulking the fixation pin 8.

The operation pedal 30 is pivotally supported with respect to the pedal bracket 5 by the first support shaft 6 into which the boss 32 formed on the upper part of the operation pedal 30 and having a substantially cylindrical shape (see FIGS. 2-4) is inserted. The operation pedal 30 has a depressing part 31 on a lower end part of the operation pedal 30. Accordingly, when the depressing operation is performed by the depressing part 31 of the operation pedal 30, the operation pedal 30 pivots around the first support shaft 6 and the depressing part 31 moves toward the vehicle front side.

The intermediate lever 35 has a lower end pivotally supported by the second support shaft 7. The intermediate lever 35 is extended upward. The operating rod R is coupled to an upper end of the intermediate lever 35 by way of a clevis. Accordingly, when the intermediate lever 35 is pivoted with the second support shaft 7 as a center, the operating rod R can be displaced in the front and back of the vehicle. That is, according to the brake pedal device 1, the braking force can be generated through the brake booster B by displacing the operating rod R toward the vehicle front side with the intermediate lever 35.

The coupling link 40 couples a front side portion of the operation pedal 30 and a rear side portion of the intermediate lever 35. The coupling link 40 is pivotally attached to the operation pedal 30 and the intermediate lever 35. One end side of the coupling link 40 is coupled to the front side portion of the operation pedal 30 by way of a connection pin 41, and hence the coupling link 40 can be pivoted with respect to the operation pedal 30 with the connection pin 41 as a center. The other end side of the coupling link 40 is coupled to the rear side portion of the intermediate lever 35 by way of a connecting pin 42, and hence the coupling link 40 can be pivoted with respect to the intermediate lever 35 with the connecting pin 42 as a center. Therefore, in the brake pedal device 1, the pivoting of the operation pedal 30 having the first support shaft 6 as a center can be transmitted to the intermediate lever 35 through the coupling link 40, so that the intermediate lever 35 can be pivoted with the second support shaft 7 as the center.

(Operation of Each Unit Involved in Depressing Operation of Operation Pedal)

Next, in the brake pedal device 1 described above, movement of each unit when the depressing operation of the operation pedal 30 is carried out will be described.

When the depressing operation is carried out with respect to the operation pedal 30, the depressing part 31 is depressed toward the vehicle front side, and thus the operation pedal 30 is pivoted with the first support shaft 6 as the center. At this time, the operation pedal 30 is pivoted toward the vehicle front upward side with the first support shaft 6 as the center, and hence the pivoting of the operation pedal 30 is transmitted to the intermediate lever 35 through the coupling link 40.

As described above, since the coupling link 40 is coupled to the rear side portion of the intermediate lever 35 by way of the connecting pin 42, the intermediate lever 35 is pivoted with the second support shaft 7 as the center accompanying the pivoting of the operation pedal 30, and the upper end of the intermediate lever 35 can be moved toward the vehicle front side. Furthermore, since the operating rod R of the brake booster B is coupled to the upper end of the intermediate lever 35 by way of the clevis, the brake pedal device 1 can push the operating rod R in an output direction (vehicle front side) in cooperation with the depressing operation of the operation pedal 30 and can generate the braking force with respect to the vehicle.

(Specific Configuration of the Pedal Bracket 5)

Next, a specific configuration of the pedal bracket 5 in the brake pedal device 1 according to the first embodiment will be described in detail with reference to the drawings. As described above, the pedal bracket 5 is configured by the first side plate member 10 and the second side plate member 20 that face each other with the side plate gap W in the vehicle width direction.

As illustrated in FIG. 1 and FIG. 2, the first side plate member 10 is a member made from a steel plate that configures a left side portion of the pedal bracket 5, and includes a side plate part 11, a plurality of insertion holes 12, a plurality of load receiving parts 13, and an attachment/securing part 16. The second side plate member 20 is a member made from a steel plate that configures a right side portion of the pedal bracket 5, and includes a side plate part 21, a plurality of insertion holes 22, a plurality of load receiving parts 23, and an attachment/securing part 26.

The first side plate member 10 and the second side plate member 20 are secured to the dash panel P on the vehicle front side at different positions by a bolt and a nut (not illustrated). The first side plate member 10 and the second side plate member 20 are jointly fastened and secured at one location by the nut 61 and the bolt 62 with respect to the vehicle body side bracket 60 located on the vehicle rear side (see FIG. 1 and FIG. 2).

As described above, the first side plate member 10 and the second side plate member 20 have the same basic configuration, and hence the specific configuration of the first side plate member 10 will be described in detail in the following, and the description on the second side plate member 20 will be omitted.

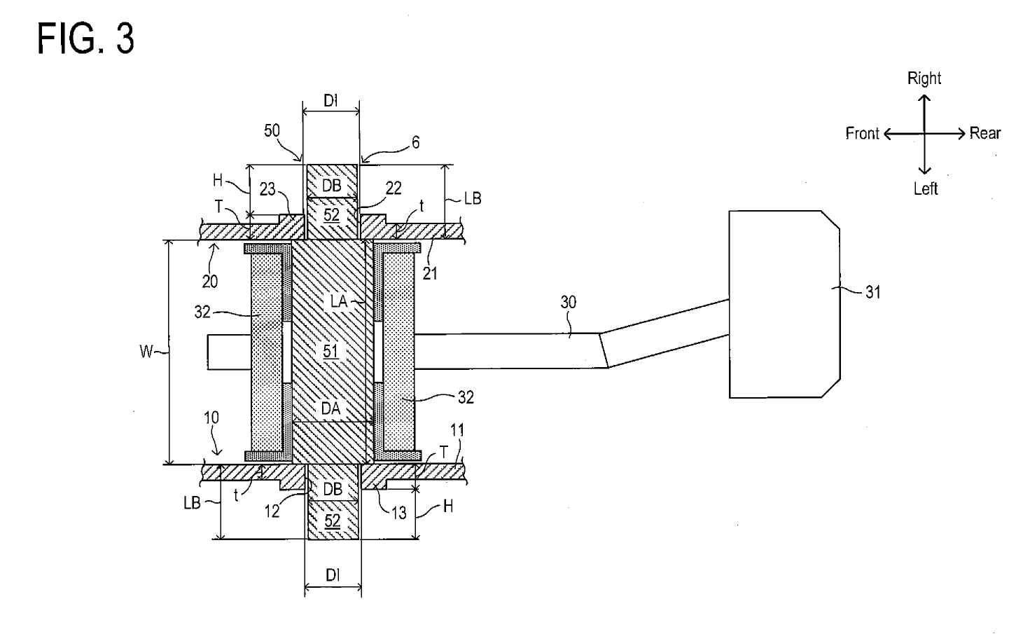

As illustrated in FIG. 1, the side plate part 11 of the first side plate member 10 forms a main part in the first side plate member 10 made from a steel plate. The side plate part 11 is a plate-like portion including a front side portion in the first side plate member 10. The side plate part 11 has a predetermined side plate thickness t (see FIGS. 3-6). The side plate thickness t is determined depending on the various conditions such as weight reduction of the pedal bracket 5 and the rigidity expected as the brake pedal device 1 and the like, and in the first embodiment, the side plate thickness t is set so as to be a comparatively thin plate thickness in order to place the importance on the weight reduction of the brake pedal device 1 and the pedal bracket 5.

In the side plate part 11 of the first side plate member 10, the plurality of insertion holes 12 are formed corresponding to the arrangement positions of the first support shaft 6, the second support shaft 7, and the fixation pin 8, and the plurality of insertion holes 12 are open in a circular shape having a predetermined insertion hole inner diameter D1. One end part of the caulking pin 50 configuring the first support shaft 6, the second support shaft 7, and the fixation pin 8 is inserted into each of the insertion holes 12.

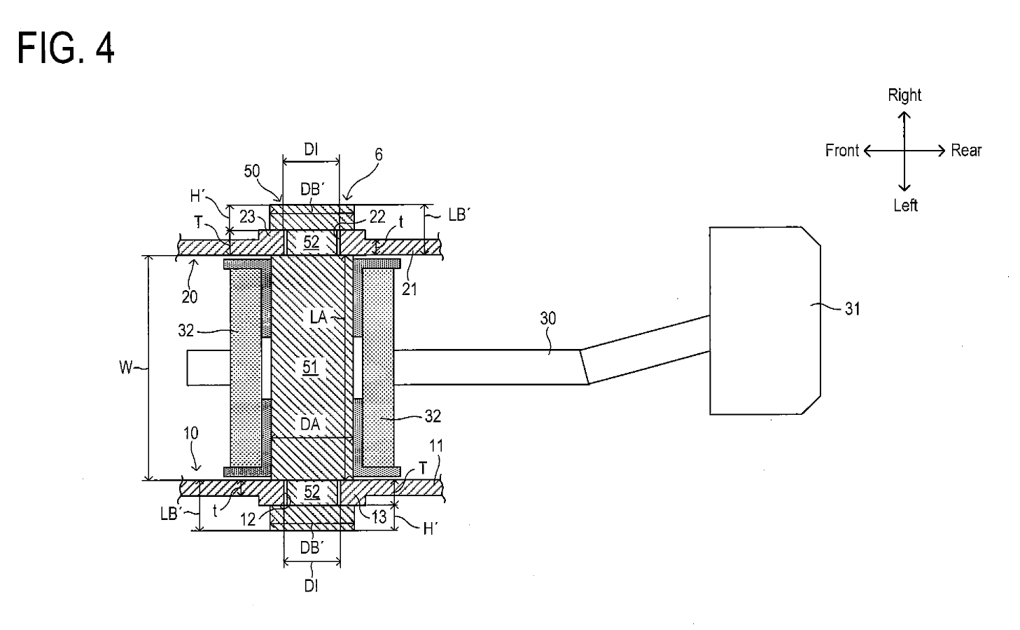

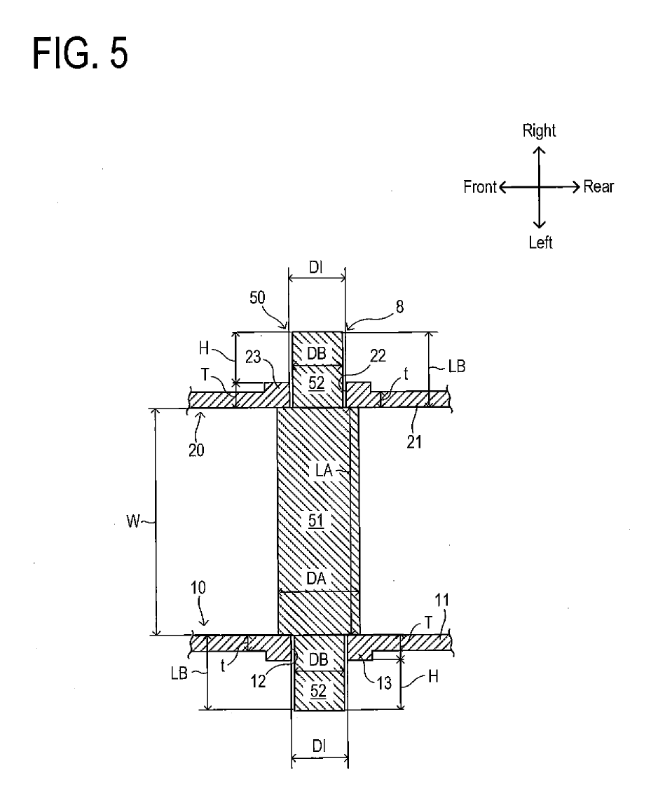

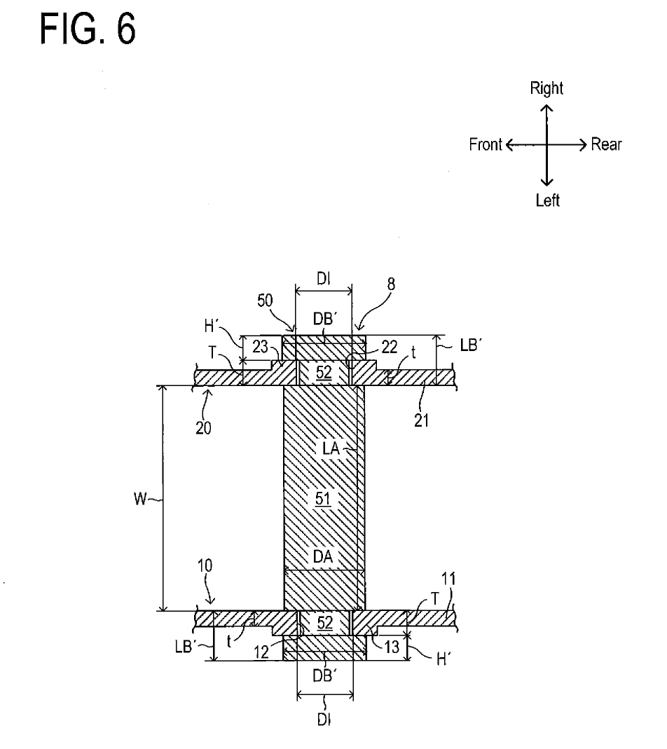

Namely, the insertion hole 12 to which the first support shaft 6 is attached is formed on the vehicle rearward side in the first side plate member 10, and one end part of the caulking pin 50 configuring the first support shaft 6 is inserted thereinto (see FIG. 3 and FIG. 4). The insertion hole 12 to which the second support shaft 7 is attached is formed on the vehicle lower front side of the insertion hole 12 of the first support shaft 6 in the side plate part 11 of the first side plate member 10, and one end part of the caulking pin 50 configuring the second support shaft 7 is inserted thereinto. The insertion hole 12 to which the fixation pin 8 is attached is formed on the vehicle forward side in the pedal bracket 5 and on an upper side of the insertion hole 12 of the second support shaft 7, and one end part of the caulking pin 50 configuring the fixation pin 8 is inserted thereinto (see FIG. 5 and FIG. 6).

The plurality of insertion holes 22 in the side plate part 21 of the second side plate member 20 are formed corresponding to the formed positions of each of the insertion holes 12 in the first side plate member 10. Accordingly, the caulking pin 50 configuring the first support shaft 6, the second support shaft 7, and the fixation pin 8 is extended substantially horizontally and substantially parallel with the vehicle width direction between the first side plate member 10 and the second side plate member 20.

In the side plate part 11 of the first side plate member 10, the plurality of load receiving parts 13 are formed around each of the insertion holes 12. The plurality of load receiving parts 13 receives a load when the caulking pin 50 is caulked. The load receiving parts 13 are formed integrally with the side plate part 11 that is the opening periphery of the insertion hole 12 by the side plate part 11 being subjected to a thickening working as a press working, and have a load receiving part plate thickness T larger than the side plate thickness t (see FIGS. 3-6).

In the same as the load receiving part 13 of the first side plate member 10, each of the load receiving parts 23 in the second side plate member 20 is formed integrally with the side plate part 21 that is the opening periphery of each of the insertion holes 22 by the side plate part 21 being subjected to a thickening working as a press working, and has the load receiving part thickness T.

As illustrated in FIG. 2, the attachment/securing part 16 is formed by bending the attachment/securing part 16 on the vehicle rearward side in the first side plate member 10 toward the inner side of the pedal bracket 5. The attachment/securing part 26 is formed by bending the attachment/securing part 26 on the vehicle rearward side in the second side plate member 20 toward the inner side of the pedal bracket 5. The attachment/securing part 16 is used when the attachment/securing part 16 and the attachment/securing part 26 of the second side plate member 20 are jointly fastened with respect to the vehicle body side bracket 60 serving as the vehicle body side member, and the pedal bracket 5 is fastened and fixed at one position.

(Specific Configuration of the Caulking Pin)

Next, a configuration of the caulking pin 50 used as the first support shaft 6, the second support shaft 7, and the fixation pin 8 in the brake pedal device 1 according to the first embodiment will be described in detail with reference to the FIGS. 3-6. As illustrated in FIG. 3 and FIG. 5, the caulking pin 50 is formed into a shaft shape by a predetermined metal material. The caulking pin 50 comprises a large-diameter portion 51 and a pair of caulked portions 52.

The large-diameter portion 51 in the caulking pin 50 is formed into a columnar shape forming an axial center part of the caulking pin 50. The large-diameter portion 51 has a circular cross section with a first outer dimension DA as a diameter, and the first outer dimension DA has a value larger than the insertion hole inner diameter DI of each of the insertion hole 12 and the insertion hole 22 (see. FIGS. 3-6). A dimension of the large-diameter portion 51 along an axial direction of the caulking pin 50 corresponds to a first axial length LA, and as illustrated in FIGS. 3-6, the first axial length LA has a value corresponding to the side plate gap W between the first side plate member 10 and the second side plate member 20 (for example, the same value as the side plate gap W, or a value slightly smaller than the side plate gap W).

Each of the caulking pin 50 in the caulking pin 50 is formed so as to protrude from axial end surfaces of the large-diameter portion 51. The each of the caulking pin 50 constitutes both ends of the caulking pin 50. Each of the caulked portions 52 is a portion deformed by caulking when the caulking pin 50 is attached to the first side plate member 10 and the second side plate member 20.

Each of the caulked portions 52 is formed into a columnar shape protruding from the axial end surfaces of the large-diameter portion 51 so as to be coaxial with an axial center of the large-diameter portion 51, and the caulked portion 52 has a circular cross section with a second outer dimension DB as a diameter. The second outer dimension DB has a value smaller than the insertion hole inner diameter DI of the insertion hole 12 and the insertion hole 22 so that each of the caulked portions 52 can insert into the insertion hole 12 and the insertion hole 22.

As illustrated in FIG. 3 and FIG. 5, each of the caulked portions 52 is formed so as to protrude from the axial end surfaces of the large-diameter portion 51 by a second axial length LB. The second axial length LB has a value larger than the load receiving part thickness T of the load receiving part 13 and the load receiving part 23. Accordingly, when each of the caulked portions 52 at both ends of the caulking pin 50 is inserted into the insertion hole 12 and the insertion hole 22, a part of each of the caulked portions 52 protrudes from the load receiving part 13 and the load receiving part 23. In the brake pedal device 1, a protrusion length of each of the caulked portions 52 (i.e. a length from an end surface of the load receiving part 13 or the load receiving part 23 to an end surface of the caulked portion 52) is referred to as “a protrusion length H”, and the protrusion length H can be calculated by deducting the load receiving part thickness T from the second axial length LB.

The load receiving part thickness T, the second axial length LB, the second outer dimension DB, and the protrusion length H in the first embodiment are determined according to conditions such as component materials of the load receiving part 13 in the first side plate member 10 and the load receiving part 23 in the second side plate member 20, component material of the caulking pin 50, and magnitude of the load to be applied to the caulking pin 50 at the time of caulking. The load receiving part thickness T, the second axial length LB, the second outer dimension DB, and the protrusion length H indicate the condition of the shapes in which the caulking pin 50 can be attached with respect to the pedal bracket 5 by caulking in an appropriate state, and the condition of the shapes is calculated by the experiment and simulation.

(Attachment/Securing of the First Support Shaft with Respect to the Pedal Bracket)

In the brake pedal device 1 configured as described above, a case in which the caulking pin 50 is attached/secured with respect to the pedal bracket 5 as the first support shaft 6 will be described in detail with reference to FIG. 3 and FIG. 4.

As illustrated in FIG. 3, firstly, the both ends of the caulking pin 50 into which the boss 32 of the operation pedal 30 was inserted (i.e. the caulked portions 52) are inserted into the insertion hole 12 of the first side plate member 10 having the side plate thickness t and the insertion hole 22 of the second side plate member 20 having the side plate thickness t, respectively. At this time, when the first side plate member 10 and the second side plate member 20 are arranged so as to come into contact with the axial end surfaces of the large-diameter portion 51 in the caulking pin 50, the second side plate member 20 is located at a position separated by the first axial length LA of the large-diameter portion 51 with respect to the first side plate member 10. Namely, the side plate gap W can be formed between the first side plate member 10 ad the second side plate member 20. At the same time, each of the caulked portions 52 is brought into a state where each of the caulked portions 52 is protruded by the protrusion length H from the axial end surfaces of the load receiving part 13 and the load receiving part 23 having the load receiving part thickness T, and the condition of the shapes calculated by the experiment and the simulation is satisfied.

Thereafter, in a state illustrated in FIG. 3, the both ends of the caulking pin 50 arranged between the first side plate member 10 and the second side plate member 20 are caulked by adding a predetermined working load through a working machine etc. At this time, parts protruding from the end surfaces of the load receiving part 13 and the load receiving part 23 in each of the caulked portions 52 of the caulking pin 50 configuring the first support shaft 6 are compressed and deformed in the axial direction of the caulking pin 50 by a working load.

As illustrated in FIG. 4, a part of each of the caulked portions 52 protruding from each of the end surfaces of the load receiving part 13 and the load receiving part 23 is formed into a cross section having a substantially circular shape with a diameter DB′ by the caulking, and is brought into a state where a part of each of the caulked portions 52 is protruded by a protrusion amount H′ from the end surfaces of the load receiving part 13 and the load receiving part 23. According to conditions of the caulking in the first embodiment (magnitude of pressure load and condition of shapes of the load receiving part 13 and the caulked portion 52 etc.), the diameter DB′ is about 1.3 times as long as the second outer dimension DB, and the protrusion amount H′ is 0.5 times as long as the protrusion length H of the caulked portion 52.

Namely, in the attachment process of the first support shaft 6 in the brake pedal device 1, even when the side plate thickness t of the side plate part in the first side plate member 10 and the second side plate member 20 is thin, the condition of the shapes of the load receiving part 13, the load receiving part 23, and the caulked portion 52 can be brought into an appropriate state, and thus appropriate caulking can be reproduced with high precision by controlling the working load of the caulking. At this time, since it is avoided that the caulking pin 50 configuring the first support shaft 6 becomes thick by caulking, occurrence of friction between the caulking pin 50 configuring the first support shaft 6 and an inner surface of the boss 32 in the operation pedal 30 can be suppressed. In the brake pedal device 1 according to the first embodiment, the caulking pin 50 configuring the first support shaft 6 can be fixed in a state where the first side plate member 10 and the second side plate member 20 are separated with the predetermined side plate gap W, and the caulking pin 50 can support the operation pedal 30 without preventing pivoting of the operation pedal 30.

The second support shaft 7 in the pedal bracket 5 is attached between the first side plate member 10 and the second side plate member 20 and fastens the both the first side plate member 10 and the second side plate member 20. The second support shaft 7 and the first support shaft 6 are the same in that the other members are pivotally supported with respect to the pedal bracket 5 and are also the same in the attachment/securing except for a difference of members of the operation pedal 30 and the intermediate lever 35. Accordingly, the description of the attachment/securing of the second support shaft 7 with respect to the pedal bracket 5 will be omitted.

(Attachment/Securing of the Fixation pin with Respect to the Pedal Bracket)

Next, a case in which the caulking pin 50 is attached/secured with respect to the pedal bracket 5 as the fixation pin 8 will be described in detail with reference to FIG. 5 and FIG. 6.

As illustrated in FIG. 5, firstly, the both ends of the caulking pin 50 configuring the fixation pin 8 (i.e. caulked portion 52) are inserted into the insertion hole 12 of the first side plate member 10 having the side plate thickness t and the insertion hole 22 of the second side plate member 20 having the side plate thickness t, respectively. At this time, when the first side plate member 10 and the second side plate member 20 are arranged so as to come into contact with the axial end surfaces of the large-diameter portion 51 in the caulking pin 50, the both members are separated by the first axial length LA of the large-diameter portion 51, and thus the side plate gap W can be formed between the first side plate member 10 and the second side plate member 20. At this time, each of the caulked portions 52 in the fixation pin 8 is brought into a state where each of the caulked portion 52 protrudes by the protrusion length H from the axial end surfaces of the load receiving part 13 and the load receiving part 23 having the load receiving part thickness T, which satisfy the condition of the shapes calculated by the experiment and simulation.

Thereafter, in a state illustrated in FIG. 5, the both ends of the caulking pin 50 arranged between the first side plate member 10 and the second side plate member 20 are caulked by adding a predetermined working load through the working machine etc. At this time, parts protruding from each of the end surfaces of the load receiving part 13 and the load receiving part 23 in each of the caulked portions 52 of the caulking pin 50 configuring the fixation pin 8 are compressed and deformed in the axial direction of the caulking pin 50 by a working load.

As illustrated in FIG. 6, in the same as the case of the first support shaft 6, a part of each of the caulked portions 52 protruding from each of the end surfaces of the load receiving part 13 and the load receiving part 23 is formed into a cross section having a substantially circular shape with the diameter DB′ by the caulking, and is brought into a state where the part of each of the caulked portions 52 is protruded by the protrusion amount H′ from each of the end surfaces of the load receiving part 13 and the load receiving part 23. According to the conditions of the caulking in the first embodiment (magnitude of pressure load and condition of shapes of the load receiving part 13 and the caulked portion 52 etc.), the diameter DB′ is about 1.3 times as long as the second outer dimension DB, and the protrusion amount H′ is 0.5 times as long as the protrusion length H of the caulked portion 52.

Namely, in the attachment process of the fixation pin 8 in the brake pedal device 1, even when the side plate thickness t of the side plate part in the first side plate member 10 and the second side plate member 20 is thin, the condition of the shapes of the load receiving part 13, the load receiving part 23, and the caulked portion 52 can be brought into an appropriate state, and thus appropriate caulking can be reproduced with high precision by controlling the working load of the caulking. In the brake pedal device 1 according to the first embodiment, the caulking pin 50 configuring the fixation pin 8 can be fixed in a state where the first side plate member 10 and the second side plate member 20 are separated with the predetermined side plate gap W.

As described above, the brake pedal device 1 according to the first embodiment includes the pedal bracket 5, the operation pedal 30, the intermediate lever 35, and the coupling link 40, and can pivot the intermediate lever 35 through the coupling link 40 in cooperation with the pivoting of the operation pedal 30 involved in the depressing operation, and hence can displace the operating rod R of the brake booster B toward the vehicle front side.

In the brake pedal device 1, the caulking pin 50 comprises the large-diameter portion 51 having the first outer dimension DA larger than the insertion hole inner diameter DI of the insertion hole 12 and the insertion hole 22 and the first axial length LA corresponding to the side plate gap W between the first side plate member 10 and the second side plate member 20, and the pair of the caulked portions 52 having the second outer dimension DB smaller than the insertion hole inner diameter DI of the insertion hole 12 and the insertion hole 22. Accordingly, according to the brake pedal device 1, when each of the caulked portions 52 is inserted into the insertion hole 12 of the first side plate member 10 and the insertion hole 22 of the second side plate member 20, respectively, a position of the first side plate member 10 and the second side plate member 20 can be determined by making the first side plate member 10 and the second side plate member 20 contact with the each of the end surfaces of the large-diameter portion 51, and the predetermined side plate gap W can be provided between the first side plate member 10 and the second side plate member 20.

In the brake pedal device 1, the first side plate member 10 and the second side plate member 20 include the load receiving part 13 and the load receiving part 23 formed in the opening peripheries of the insertion hole 12 and the insertion hole 22, respectively, and the load receiving part 13 and the load receiving part 23 have the load receiving part thickness T. The pair of the caulked portions 52 in the caulking pin 50 is formed so as to protrude along the axial direction of the caulking pin 50 from the end surfaces of the large-diameter portion 51 by the second axial length LB larger than the load receiving part thickness T (see FIG. 3 and FIG. 5). Accordingly, according to the brake pedal device 1, regardless of the side plate thickness t of the side plate part 11 of the first side plate member 10 and the side plate part 21 of the second side plate member 20 other than the load receiving part 13 and the load receiving part 23, it is possible to make common configurations of the load receiving part 13 of the first side plate member 10, the load receiving part 23 of the second side plate member 20, and the pair of caulked portions 52 in the caulking pin 50, contributing to maintaining high caulking precision.

According to the brake pedal device 1, since the caulking pin 50 is used as the first support shaft 6, a function of pivotally supporting the operation pedal 30 can be given to the caulking pin 50 in addition to a function of fixing the first side plate member 10 and the second side plate member 20. As illustrated in FIG. 3 and FIG. 4, according to the brake pedal device 1, since an appropriate caulking can be reproduced by the configurations of the pair of caulked portions 52 in the caulking pin 50, the load receiving part 13, and the load receiving part 23, the operation pedal 30 can be supported by the caulking pin 50 in such a manner as to avoid preventing the pivoting of the operation pedal 30.

Further, according to the brake pedal device 1 described in the first embodiment, since the caulking pin 50 is used as the second support shaft 7, a function of pivotally supporting the intermediate lever 35 can be given to the caulking pin 50 in addition to a function of fixing the first side plate member 10 and the second side plate member 20. According to the brake pedal device 1, since an appropriate caulking can be reproduced by the configurations of the pair of the caulked portions 52 in the caulking pin 50, the load receiving part 13, and the load receiving part 23, the intermediate lever 35 can be supported by the caulking pin 50 in such a manner as to avoid preventing the pivoting of the intermediate lever 35.

According to the brake pedal device 1 described in the first embodiment, since the side plate part 11 of the first side plate member 10 and the side plate part 21 of the second side plate member 20 are formed with plate thickness (side plate thickness t) thinner than the load receiving part thickness T that is the plate thickness of the load receiving part 13 and the load receiving part 23, weight reduction of the brake pedal device 1 and the pedal bracket 5 can be achieved. According to the brake pedal device 1, since even when weight reduction of the brake pedal device 1 and the pedal bracket 5 is achieved, the configurations of the load receiving part 13, the load receiving part 23, and the caulked portion 52 are not changed, an appropriate caulking of the caulking pin 50 can be reproduced with high precision.

As illustrated in FIGS. 3-6, since the load receiving part 13 and the load receiving part 23 are formed integrally with the first side plate member 10 and the second side plate member 20, for example, the load receiving part 13 and the load receiving part 23 can be formed into the first side plate member 10 and the second side plate member 20, respectively by a metal plate forming the first side plate member 10 and the second side plate member 20 being subjected to a thickening working as a press working, which can improve the work efficiency in manufacturing the brake pedal device 1.

### Second Embodiment

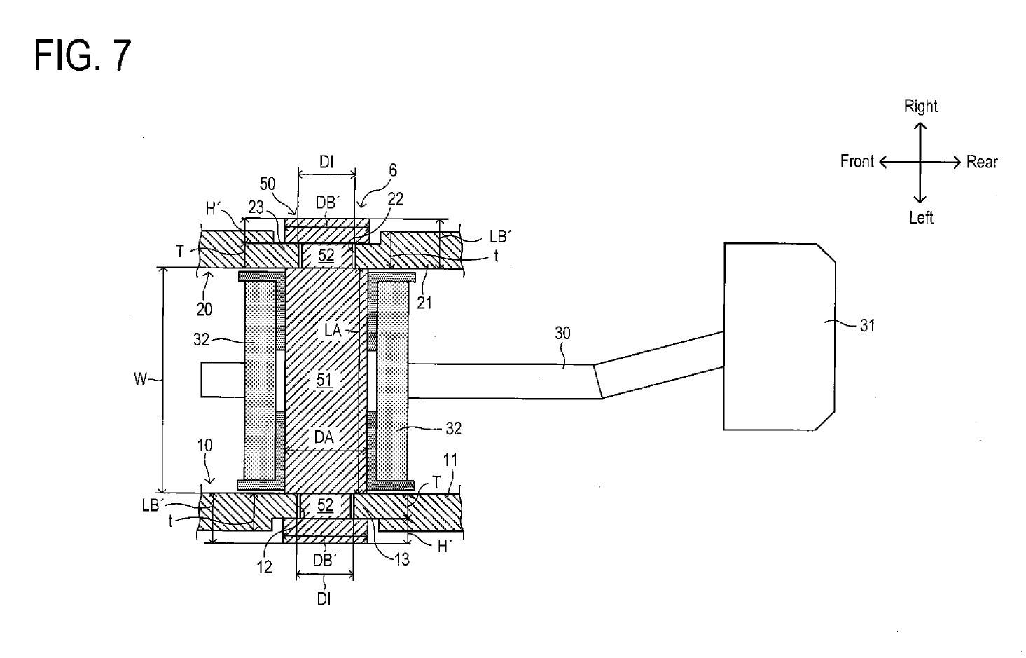

Next, a schematic configuration of the brake pedal device 1 according to an embodiment (the second embodiment) different from the first embodiment described above will be described in detail with reference to FIG. 7. The brake pedal device 1 according to the second embodiment has the same configuration as the brake pedal device 1 according to the first embodiment described above except for configurations of the side plate part 11 in the first side plate member 10 and the side plate part 21 in the second side plate member 20. Accordingly, the description of the configuration same as the first embodiment will be omitted in the following and the configuration different from the first embodiment will be described in detail.

(Schematic Configuration of the Brake Pedal Device According to the Second Embodiment)

In the brake pedal device 1 according to the second embodiment, the pedal bracket 5 is also fastened with respect to the vehicle compartment side of the dash panel P using a bolt and the like. The pedal bracket 5 has a pair of side plates (the first side plate member 10 and the second side plate member 20) that face each other with a gap in the vehicle width direction. The first side plate member 10 according to the second embodiment has the side plate part 11, the plurality of insertion holes 12, the plurality of the load receiving parts 13, and the attachment/securing part 16 in the same as the first embodiment, and the second side plate member 20 according to the second embodiment has the side plate part 21, the plurality of insertion holes 22, the plurality of load receiving parts 23, and the attachment/securing part 26.

In the first side plate member 10 and the second side plate member 20 according to the second embodiment, the side plate part 11 and the side plate part 21 form a main part of the first side plate member 10 and the second side plate member 20 made of a steel plate, and have the side plate thickness t larger than the load receiving part thickness T of the load receiving part 13 and the load receiving part 23 (see FIG. 7). The brake pedal device 1 according to the second embodiment is different from the first embodiment in that the brake pedal device 1 according to the second embodiment places importance on realization of high rigidity as the brake pedal device 1 for its configuration.

The configuration of the second embodiment is the same as the first embodiment except for the side plate thickness t, and the both the second embodiment and the first embodiment have the same value. Namely, the insertion hole inner diameter DI of the insertion hole 12 and the insertion hole 22, the load receiving part thickness T of the load receiving part 13 and the load receiving part 23, the first axial length LA and the first outer dimension DA of the large-diameter portion 51, the second axial length LB, the second outer dimension DB and the protrusion length H of the caulked portion 52 have the same value as the first embodiment.

(Attachment/Securing of the Caulking Pin with Respect to the Pedal Bracket According to the Second Embodiment)

Attachment/securing of the caulking pin 50 with respect to the pedal bracket 5 according to the second embodiment will be described in detail with reference to FIG. 7 giving an example of a case in which the caulking pin 50 is attached/secured as the first support shaft 6.

In this case, firstly, the both ends of the caulking pin 50 (i.e. caulked portion 52) in a state in which the boss 32 of the operation pedal 30 is inserted are inserted into the insertion hole 12 of the first side plate member 10 having the side plate thickness t larger than the load receiving part thickness T and the insertion hole 22 of the second side plate member 20 having the side plate thickness t larger than the load receiving part thickness T, respectively. At this time, when the first side plate member 10 and the second side plate member 20 are arranged so as to come into contact with the axial end surfaces of the large-diameter portion 51 in the caulking pin 50, the second side plate member 20 is separated by the first axial length LA of the large-diameter 51 from the first side plate member 10, and the side plate gap W can be formed between the first side plate member 10 and the second side plate member 20. At the same time, even when the side plate part 11 and the side plate part 21 are configured to have the side plate thickness t larger than the load receiving part thickness T, each of the caulked portions 52 is brought into a state where each of the caulked portions 52 protrudes by the protrusion length H from the axial end surfaces of the load receiving part 13 and the load receiving part 23 having the load receiving part thickness T, which satisfy the condition of the shapes calculated by the experiment and simulation.

Thereafter, the both ends of the caulking pin 50 arranged between the first side plate member 10 and the second side plate member 20 are caulked by adding a predetermined working load through a working machine etc. At this time, in the second embodiment, parts protruding from the each of the end surfaces of the load receiving part 13 and the load receiving part 23 in each of the caulked portions 52 of the caulking pin 50 configuring the first support shaft 6 are also compressed and deformed in the axial direction of the caulking pin 50 by a working load.

As illustrated in FIG. 7, a part of each of the caulked portions 52 protruding from each of the end surfaces of the load receiving part 13 and the load receiving part 23 is formed into a cross section having a substantially circular shape with the diameter DB′ by the caulking, and is brought into a state where the part of each of the caulked portions 52 is protruded by the protrusion amount H′ from the end surfaces of the load receiving part 13 and the load receiving part 23. In the conditions regarding the caulking in the second embodiment (magnitude of pressure load and the condition of the shapes of the load receiving part 13 and the caulked portion 52 etc.), the diameter DB′ is also about 1.3 times as long as the second outer dimension DB, and the protrusion amount H′ is also 0.5 times as long as the protrusion length H of the caulked portion 52.

Namely, in the attachment process of the first support shaft 6 in the brake pedal device 1, even when the side plate thickness t of the side plate parts in the first side plate member 10 and the second side plate member 20 is thicker than the load receiving part thickness T, the condition of the shapes of the load receiving part 13, the load receiving part 23, and the caulked portion 52 can be brought into an appropriate state, and thus appropriate caulking can be reproduced with high precision by controlling the working load of the caulking. At this time, since it is avoided that the caulking pin 50 configuring the first support shaft 6 becomes thick by caulking, occurrence of friction between the caulking pin 50 configuring the first support shaft 6 and the inner surface of the boss 32 in the operation pedal 30 can be suppressed. In the brake pedal device 1 according to the second embodiment, the caulking pin 50 configuring the first support shaft 6 can also be fixed in a state where the first side plate member 10 and the second side plate member 20 are separated with the predetermined side plate gap W, and the caulking pin 50 can also support the operation pedal 30 without preventing pivoting of the operation pedal 30.

In the second embodiment, the caulking pin 50 configuring the second support shaft 7 is attached/secured in the same way as in the first embodiment. The caulking pin 50 configuring the fixation pin 8 is the same as the caulking pin 50 configuring the first support shaft 6 described above in that the first side plate member 10 and the second side plate member 20 are fixed in a state where the first side plate member 10 and the second side plate member 20 are separated with the predetermined side plate gap W, and the above both of the caulking pins 50 are attached/secured in the same way. Accordingly, the description of the attachment /securing of the second support shaft 7 and the fixation pin 8 with respect to the pedal bracket 5 according to the second embodiment will be omitted.

As described above, according to the brake pedal device 1 in the second embodiment 2, since the side plate part 11 of the first side plate member 10 and the side plate part 21 of the second side plate member 20 are formed with the thickness (side plate thickness t) thicker than the load receiving part thickness T that is the plate thickness of the load receiving part 13 and the load receiving part 23, which is different from the first embodiment, the rigidity of the brake pedal device 1 and the pedal bracket 5 can be improved. According to the brake pedal device 1, even when the rigidity of the brake pedal device 1 and the pedal bracket 5 improves, the configurations of the load receiving part 13, the load receiving part 23, and the caulked portion 52 are not changed, and thus an appropriate caulking with respect to the caulking pin 50 can be reproduced with high precision.

According to the brake pedal device 1 in the second embodiment, since the brake pedal device 1 in the second embodiment has the same configuration as the brake pedal device 1 in the first embodiment except for the side plate thickness t of the side plate part 11 of the first side plate member 10 and the side plate part 21 of the second side plate member 20, the brake pedal device 1 in the second embodiment can bring out the same effect as the brake pedal device 1 in the first embodiment.

In the embodiment described above, the brake pedal device 1 is an example of the vehicle operation pedal device in the present disclosure, and the pedal bracket 5 is an example of the pedal bracket in the present disclosure. While the first side plate member 10 and the second side plate member 20 are an example of the pair of side plates in the present disclosure, the first support shaft 6, the second support shaft 7, the fixation pin 8, and the caulking pin 50 are an example of the caulking pin in the present disclosure. While the operation pedal 30 is an example of the operation pedal in the present disclosure, the insertion hole 12 and the insertion 22 are an example of the insertion hole in the present disclosure. While the load receiving part 13 and the load receiving part 23 are an example of the load receiving part in the present disclosure, and the load receiving part thickness T is an example of the first dimension in the present disclosure. While the large-diameter portion 51 is an example of the large-diameter portion in the present disclosure, the caulked portion 52 is an example of the caulked portion in the present disclosure. While the intermediate lever 35 is an example of the intermediate lever in the present disclosure, the coupling link 40 is an example of the coupling link in the present disclosure. The second axial length LB is an example of the second dimension in the present disclosure.

Although the present disclosure has been described based on the embodiments, the present disclosure is not limited by the above embodiment and various modifications can be done within a scope of the disclosure. For example, although the above embodiments has a configuration that the side plate thickness t of the side plate part 11 of the first side plate member 10 and the side plate part 21 of the second side plate member 20 has one of a constant value smaller than the load receiving part thickness T and a constant value larger than the load receiving part thickness T, this configurations are not to be construed as limitations to such specifically described embodiments. In the side plate part 11 of the first side plate member 10 and the side plate part 21 of the second side plate member 20, the side plate thickness t may be variously changed except for the load receiving part 13 and the load receiving part 23.

In the embodiments as described above, although the first support shaft 6, the second support shaft 7 and the fixation pin 8 are configured by the caulking pin 50, and the first side plate member 10 and the second side plate member 20 are fixed by caulking, the present application is not limited to this configuration. Only any one of the first support shaft 6, the second support shaft 7, and the fixation pin 8 may be applied to this configuration, and more caulking pins 50 may be used in order to fix at positions different from the above three positions.

In the embodiment as described above, although the load receiving part 13 and the load receiving part 23 are integrally formed by the first side plate member 10 and the second side plate member 20 being subjected to a thickening working, the present application is not limited to this configuration. For example, the load receiving part 13 and the load receiving part 23 may be formed as an another member having the annular shape with the load receiving part thickness T and the insertion hole 22 therein. In this case, it is desirable that an opening corresponding to the another member is formed in the attachment positions of the caulking pin 50 in the first side plate member 10 and the second side plate member 20, and the another member is fixed to the opening by welding etc. for integration.

The present disclosure can be made even though the load receiving part 13 and the load receiving part 23 are formed by a plurality of members. For example, the load receiving part 13 etc. may be configured by forming the insertion hole 12 and the insertion hole 22 in the side plate part 11 and the side plate part 21 having the side plate thickness t, and then fixing one or more flat washers with a circular opening having the insertion hole inner diameter DI coaxially with the insertion hole 12 etc. with the one or more flat washers superposed. In this case, the total value of the plate thicknesses of the side plate thickness t and the flat washer is set to be equal to the load receiving part thickness T.

In the embodiment as described above, although the intermediate lever 35 and the second support shaft 7 are located on the vehicle forward side in the brake pedal device 1, and the operation pedal 30 and the first support shaft 6 are located on the rearward side thereof, the present application is not limited to this configuration. Namely, the present disclosure is applicable to a configuration wherein the operation pedal 30 and the first support shaft 6 are located on the vehicle forward side in the brake pedal device 1, and the intermediate lever 35 and the second support shaft 7 are located on the rearward side thereof.

In the embodiment as described above, although the present disclosure is applied to a vehicle operation pedal device (for example, brake pedal device 1) having a configuration wherein the operation pedal and the intermediate lever are pivotally provided by the pedal bracket, and the operation pedal and the intermediate lever are connected to each other via a coupling link, the present application is not limited to this configuration. For example, a configuration including a pedal bracket configured by a pair of side plates and an operation pedal may be accepted, and the present disclosure is applicable to a vehicle operation pedal device pivotally holding the operation pedal only and displacing an output member by pivoting of the operation pedal.

In the embodiment as described above, although the present disclosure is applied to a brake pedal device 1 for a service brake, the present disclosure is appropriately applicable to a vehicle operation pedal device used for some operations with respect to a vehicle (for example, an accelerator pedal device, a clutch pedal device, and a foot-operated parking brake operation device etc.) and including a pedal bracket having a pair of side plates.

Further, if each operation in the vehicle operation pedal device according to the present disclosure can be realized, shapes of component members can be appropriately changed. The shape of each component member is not limited to the shape of each component member of the brake pedal device 1 in the embodiment as described above, and for example, each of the shapes of the component members may be changed in order to avoid interference between component members. Although a product of the second outer dimension DB and the protrusion length H and a product of the diameter DB′ and the protrusion amount H′ indicates a different value before and after the caulking in the embodiment as described above, which is caused by a counter bore part formed inside the caulked portion 52.

The following description is the list of aspects of the embodiments of the present application. The first vehicle operation pedal device is a vehicle operation pedal device comprising: a pedal bracket that includes a pair of side plates arranged with a predetermined gap in a vehicle width direction, and that is secured to a vehicle body side member; a caulking pin that is inserted into each insertion hole formed on the pair of side plates in the pedal bracket, and that fixes the pair of side plates by caulking; and an operation pedal that is pivotally arranged with respect to the pedal bracket between the pair of side plates, and that includes a depressing part used for a depressing operation toward a vehicle front side; wherein the pair of side plates includes a load receiving part, in which formed in opening periphery of the insertion hole, configured to a plate thickness of a predetermined first dimension, and the caulking pin including: a large-diameter portion configured to an outer diameter dimension larger than an inner diameter dimension of the insertion hole and an axial length corresponding to the gap between the pair of side plates; and a pair of caulked portions that protruded along an axial direction of the caulking pin from each of end surfaces of the large-diameter portion by a predetermined second dimension larger than the first dimension, wherein the pair of caulked portions that includes an outer diameter dimension smaller than the inner diameter dimension of the insertion hole and that deformed in the axial direction by caulking.

The first vehicle operation pedal device comprises the pedal bracket including the pair of side plates, the caulking pin that is inserted into the each insertion hole formed on the pair of side plates, and the operation pedal that is pivotally arranged with respect to the pedal bracket. The first vehicle operation pedal device is configured to be able to be depressing operation by the depressing part of the operation pedal. In the first vehicle operation pedal device, the caulking pin includes the large-diameter portion configured to the outer diameter dimension larger than the inner diameter dimension of the insertion hole and the axial length corresponding to the gap between the pair of side plates, and the pair of caulked portions including the outer diameter smaller than the inner diameter dimension of the insertion hole. Therefore, according to the first vehicle operation pedal device, when each of the caulked portions is inserted into the insertion holes of the each side plate, the position of the each side plate can be determined by making the each side plate contact with the each of the end surfaces of the large-diameter portion, and the predetermined gap can be provided between the pair of side plates. In the first vehicle operation pedal device, the pair of side plates includes the load receiving part, in which formed in the opening periphery of the insertion hole, configured to the plate thickness of the predetermined first dimension, and the pair of caulked portions in the caulking pin protrudes along the axial direction of the caulking pin from the each of end surfaces of the large-diameter portion by the predetermined second dimension larger than the first dimension. Therefore, according to the first vehicle operation pedal device, regardless of the plate thickness of each side plate and the like other than the load receiving parts, it is possible to make common configurations of the load receiving parts of each side plate in the pedal bracket and the pair of caulked portions in the caulking pin, with contributing to maintaining high caulking precision.

The second vehicle operation pedal device is the first vehicle operation pedal device, wherein the caulking pin, in which pivotally supports the operation pedal between the pair of side plate, fixes the pair of side plates by deformation of the pair of caulked portions by caulking.

According to the second vehicle operation pedal device, a function of pivotally supporting the operation pedal can be given to the caulking pin in addition to a function of fixing the pair of side plates. Further, according to the second vehicle operation pedal device, since an appropriate caulking can be realized by the configurations of the pair of caulked portions in the caulking pin and the load receiving parts around the insertion holes, the operation pedal can be supported by the caulking pin in such a manner as to avoid preventing the pivoting of the operation pedal.

The third vehicle operation pedal device is the first vehicle operation pedal device comprising: an intermediate lever that is pivotally supported with respect to the pedal bracket between the pair of side plates and that displaces a predetermined output member toward the vehicle front side by pivoting of the intermediate lever in an output direction; and a coupling link, in which coupled the operation pedal and the intermediate lever, pivots the intermediate lever in the output direction in cooperation with depressing operation of the operation pedal; wherein the caulking pin, in which pivotally supports the intermediate lever between the pair of side plates, fixes the pair of side plates by deformation of the pair of caulked portions by caulking.

The third vehicle operation pedal device comprises the intermediate lever and the coupling link, and the intermediate lever can be pivoted in the output direction by transmitting the pivoting of the operation pedal involved in a depressing operation to the intermediate lever via the coupling link. According to the third vehicle operation pedal device, a function of pivotally supporting the intermediate lever can be given to the caulking pin in addition to the function of fixing the pair of side plates. Further, according to the third vehicle operation pedal device, since an appropriate caulking can be realized by the configurations of the pair of caulked portions in the caulking pin and the load receiving parts around the insertion holes, the intermediate lever can be supported by the caulking pin in such a manner as to avoid preventing the pivoting of the intermediate lever.

The fourth vehicle operation pedal device is the first vehicle operation pedal device, wherein the pair of side plates is formed with plate thickness thinner than the first dimension that is the plate thickness of the load receiving part.

According to the fourth vehicle operation pedal device, since the pair of side plates is formed with the plate thickness thinner than the first dimension that is the plate thickness of the load receiving part, weight reduction of the pedal bracket and the fourth vehicle operation pedal device can be achieved. Further, according to the fourth vehicle operation pedal device, even though the weight reduction of the pedal bracket etc. can be achieved, an appropriate caulking of the caulking pin can be performed with high precision since the configurations of the load receiving part and the caulked portion are not changed.

The fifth vehicle operation pedal device is the first vehicle operation pedal device, wherein the pair of side plates is formed with plate thickness thicker than the first dimension that is the plate thickness of the load receiving part.

According to the fifth vehicle operation pedal device, since the pair of side plates is formed with the plate thickness thicker than the first dimension that is the plate thickness of the load receiving part, rigidity of the pedal bracket and the fifth vehicle operation pedal device can be improved. Further, according to the fifth vehicle operation pedal device, even though the rigidity of the pedal bracket etc. is improved, an appropriate caulking of the caulking pin can be performed with high precision since the configurations of the load receiving part and the caulked portion are not changed.

The sixth vehicle operation pedal device is the first vehicle operation pedal device, wherein the load receiving part is formed integrally with the pair of side plates formed the pedal bracket.

According to the sixth vehicle operation pedal device, since the load receiving part is formed integrally with the pair of side plates formed the pedal bracket, for example, the load receiving part can be formed on the side plates by a metal plate forming the side plates being subjected to a thickening working as a press working, which can improve work efficiency in manufacturing the fifth vehicle operation pedal device.

The present disclosure comprises the pedal bracket including the pair of side plates, the caulking pin that is inserted into the each insertion hole formed on the pair of side plates, and the operation pedal that is pivotally arranged with respect to the pedal bracket. Since the caulking pin includes the large-diameter portion configured to the outer diameter dimension larger than the inner diameter dimension of the insertion hole and the axial length corresponding to the gap between the pair of side plates, and the pair of caulked portions including the outer diameter smaller than the inner diameter dimension of the insertion hole, the predetermined gap can be provided between the pair of side plates. The pair of side plates includes the load receiving part, in which formed in the opening periphery of the insertion hole, configured to the plate thickness of the predetermined first dimension, and the pair of caulked portions protrudes along the axial direction of the caulking pin from the each of end surfaces of the large-diameter portion by the predetermined second dimension larger than the first dimension. Accordingly, regardless of the plate thickness of each side plate and the like other than the load receiving parts, it is possible to make common configurations of the load receiving parts of each side plate in the pedal bracket and the pair of caulked portions in the caulking pin.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A vehicle operation pedal device comprising:
a pedal bracket that includes a pair of side plates arranged with a predetermined gap in a vehicle width direction, and that is secured to a vehicle body side member;
a caulking pin that is inserted into each insertion hole formed on the pair of side plates in the pedal bracket, and that fixes the pair of side plates by caulking; and
an operation pedal that is pivotally arranged with respect to the pedal bracket between the pair of side plates, and that includes a depressing part used for a depressing operation toward a vehicle front side; wherein
the pair of side plates includes a load receiving part, in which formed in opening periphery of the insertion hole, configured to a plate thickness of a predetermined first dimension, and
the caulking pin including:
a large-diameter portion configured to an outer diameter dimension larger than an inner diameter dimension of the insertion hole and an axial length corresponding to the gap between the pair of side plates; and
a pair of caulked portions that protruded along an axial direction of the caulking pin from each of end surfaces of the large-diameter portion by a predetermined second dimension larger than the first dimension, wherein the pair of caulked portions that includes an outer diameter dimension smaller than the inner diameter dimension of the insertion hole and that deformed in the axial direction by caulking.

2. The vehicle operation pedal device according to claim 1, wherein
the caulking pin, in which pivotally supports the operation pedal between the pair of side plate, fixes the pair of side plates by deformation of the pair of caulked portions by caulking.

3. The vehicle operation pedal device according to claim 1 comprising:
an intermediate lever that is pivotally supported with respect to the pedal bracket between the pair of side plates and that displaces a predetermined output member toward the vehicle front side by pivoting of the intermediate lever in an output direction; and
a coupling link, in which coupled the operation pedal and the intermediate lever, pivots the intermediate lever in the output direction in cooperation with depressing operation of the operation pedal; wherein
the caulking pin, in which pivotally supports the intermediate lever between the pair of side plates, fixes the pair of side plates by deformation of the pair of caulked portions by caulking.

4. The vehicle operation pedal device according to claim 1, wherein
the pair of side plates is formed with plate thickness thinner than the first dimension that is the plate thickness of the load receiving part.

5. The vehicle operation pedal device according to claim 1, wherein
the pair of side plates is formed with plate thickness thicker than the first dimension that is the plate thickness of the load receiving part.

6. The vehicle operation pedal device according to claim 1, wherein
the load receiving part is formed integrally with the pair of side plates formed the pedal bracket.
